(19) United States
(12) Patent Application Publication
(10) Pub. No.: US 2007/0178321 A1
(43) Pub. Date: Aug. 2, 2007

(54) CURABLE SILICONE COATING

(75) Inventor: Hans E. Haas, Stow, OH (US)

Correspondence Address: GIFFORD, KRASS, SPRINKLE, ANDERSON et. al., 2701 TROY CENTER DRIVE, STE. 330, TROY, MI, 48007, US

(73) Assignee: Illinois Tool Works, Inc., Glenview, IL (US)

(21) Appl. No.: 11/669,979

(22) Filed: Feb. 1, 2007

Related U.S. Application Data
(60) Provisional application No. 60/764,095, filed on Feb. 1, 2006.

(51) Int. Cl. B32B 27/00; C08L 83/04; B01F 3/04

(52) U.S. Cl. 428/447; 516/1; 524/588

(57) ABSTRACT

A curable silicone composition is provided that includes a silanol functional silicone fluid. A crosslinker reactive with the silanol functional silicone fluid is combined with the silanol fluid to yield a capped reactive silanol fluid. The composition is provided with a propellant in an aerosol container under pressure so as to expel the capped reactive silanol fluid along with a diluent such as a nonvolatile unreactive silicone, an organic plasticizer, a volatile organic solvent, or a combination thereof. A film produced from this composition provides a plastic or rubber substrate with a high gloss finish with desirable wear properties. The inclusion of the optional diluent and the optional propellant facilitates aerosol application of the curable silicone composition as a thin film coating. An additional attribute of a curable silicone composition as described herein is that a silicone coating cures from the capped reactive silanol fluid in ambient air at 20° Celsius in 60 minutes or less and is independent of cure catalysts that contain tin, titanate, zirconate or amine. A resultant coating is applied to the sidewall of a vehicle tire as an aesthetic and protectorant.

### CROSS-REFERENCE TO RELATED APPLICATIONS

This application claims priority of U.S. Provisional Patent Application Ser. No. 60/764,095 filed Feb. 1, 2006, which is incorporated herein by reference.

### FIELD OF THE INVENTION

The present invention in general relates to a curable silicone protective coating composition and in particular to a composition maintaining gloss longer than existing compositions that is removable with mild detergent and moderate scrubbing.

### BACKGROUND OF THE INVENTION

The maintenance and aesthetics of numerous objects requires the use of a protective and/or appearance enhancing coating. This is especially true of plastic and rubber vehicle components such as dashboards and tires. Exposure to environmental pollutants and extremes of temperature quickly degrade the appearance of these components, while chronic environmental exposure leads to the premature embrittlement of these components.

Numerous conventional tire and vinyl care products are available based on unreactive silicone fluids. One class of such products are water based and afford a limited cleaning effect and leave a satin to flat mat protective finish associated with a residual silicone fluid. Another class of conventional silicone fluid products are solvent based solutions of the same general class of silicone fluids that are applied to a precleaned surface to achieve a high gloss surface associated with a residual higher molecular weight silicone fluid. These solvent-based silicone fluid products intended to provide a high gloss finish are commonly referred to as “tire wet” products. While both the water-based tire shine products and the solvent-based tire wet product have significant acceptance in the marketplace, they are still deficient in several respects. In the case of a tire, relatively low viscosity silicone fluids, typically less than 60,000 Cst, are stripped from a tire by centripetal force and are prone to contaminate exterior painted surfaces with the silicone fluid. This fluid traps dirt and debris and extracts certain components of the rubber tire to yield a brownish oily residue. This low viscosity of conventional “tire wet” silicone fluid protectants also has the unintended consequence of quickly dissipating from a substrate as a result of normal driving conditions and particularly from driving in inclement weather. With a loss of high gloss finish, the substrate quickly turns to a satin or flat finish that requires frequent reapplication to maintain the desired high gloss protective coating.

Thus, there exists a need for a curing silicone fluid based protectant for plastic and rubber surfaces that addresses the limitations of conventional products so as to maintain a desired surface gloss for a longer period of time and is amenable to removal with detergent and moderate scrubbing.

### SUMMARY OF THE INVENTION

A curable silicone composition is provided that includes a silanol functional silicone fluid. A crosslinker reactive with the silanol functional silicone fluid is combined with the silanol fluid to yield a capped reactive silanol fluid. The composition is provided with a propellant in an aerosol container under pressure so as to expel the capped reactive silanol fluid along with a diluent such as a nonvolatile unreactive silicone, an organic plasticizer, a volatile organic solvent, or a combination thereof. A film produced from this composition provides a plastic or rubber substrate with a high gloss finish with desirable wear properties. The inclusion of the optional diluent and the optional propellant facilitates aerosol application of the curable silicone composition as a thin film coating. An additional attribute of a curable silicone composition as described herein is that a silicone coating cures from the capped reactive silanol fluid in ambient air at 20° Celsius in 60 minutes or less and is independent of cure catalysts that contain tin, titanate, zirconate or amine. A resultant coating is applied to the sidewall of a vehicle tire as an aesthetic and protectorant.

### DETAILED DESCRIPTION OF THE PREFERRED EMBODIMENTS

The present invention has utility as a protectant film that varies from an oily gel-like gloss to a tack-free high gloss film.

According to the present invention, a silanol terminated silicone fluid is reacted with a silane crosslinker to produce a capped reactive silicone fluid having reactive moieties associated with the crosslinker. The resulting reactive silicone fluid is curable upon application to a desired plastic or rubber substrate absent a condensation catalyst and in the presence of atmospheric moisture. The reactive silicone fluid resulting from the reaction of a silanol fluid with a silane crosslinker is optionally diluted with a nonreactive silicone alone, or in combination with an optional organic solvent in which the constituents have solubility. Application to a substrate is further facilitated by inclusion of a propellant allowing for aerosol application.

A silanol fluid according to the present invention is defined to include a condensation curing silicone polymer having a covalent bond between a silicon atom and oxygen atom of a hydroxyl moiety and having a viscosity of from 100 to 1,000,000 centistokes. Preferably a silanol fluid has a viscosity of from 500 to 200,000 centistokes and more preferably from 2000 to 80,000 centistokes.

The reaction of such a silanol fluid with a silicone crosslinker yields a curable fluid capable of moisture cure on a desired plastic or rubber substrate absent a condensation catalyst. Suitable silane crosslinkers illustratively include methyltrimethoxysilane, vinyltrimethoxysilane, methyltriethoxysilane, vinyltriethoxysilane, methyltriacetoxysilane, vinyltriethoxysilane, methyltriacetoxysilane, methyl tris-(N-methylbenzamido)silane, methyl tris-(isopropenoxy)silane, methyl tris-(cyclohexylamino)silane, methyl tris-(methyl ethyl ketoximino)silane, vinyl tris-(methyl ethyl ketoximino)silane, methyl tris-(methyl isobutyl ketoximino)silane, vinyl tris-(methyl isobutyl ketoximino)silane, tetrakis-(methyl ethyl ketoximino)silane, tetralis-(methyl isobutyl ketoximino)silane, tetrakis-(methyl amyl ketoximino)silane, dimethyl bis-(methyl ethyl ketoximino) silane, methyl vinyl bis-(methyl ethyl ketoximino)silane, methyl vinyl bis-(methyl isobutyl ketoximino)silane, methyl vinyl bis-(methyl amyl ketoximino)silane, tetrafunctional alkoxy-ketoxime silanes, tetrafunctional alkoxy-ketoximino silanes, enoxysilanes; amide analogs of each of the preceding; or amine analogs of each of the preceding.

The stoichiometry of silanol fluid to silane crosslinker is such that there is one crosslinker molecule able to react with each hydroxyl moiety present in the silanol fluid. More preferably, the silane crosslinker is present in a stoichiometric excess of from 5 to 1000 mole percent, where the excess serves to stabilize the composition against transient exposure to moisture in normal handling and on the shelf. Even higher excesses may be used when the total silanol fluid level is tie finished composition is at the low end of the operable range. The resulting crosslinker-capped silanol fluid is readily stored for several months in an anhydrous state. Application of the capped silanol fluid to a desired substrate under ambient outdoor environmental conditions is sufficient to induce cure without resort to an added conventional condensation catalyst such as those inclusive of tin, titanate, zirconate or amine functionalities. It is appreciated that neat capped silanol fluids cure to a tack-free high gloss surface in contrast to one diluted with unreactive silicone fluids (or organic unreactive diluents) with cure leading to a gelatinous oily coating. Factors relevant in determining the finish of a cured coating illustratively include silanol fluid branching density, reactivity of capping moieties towards cure, kinetics of capped silanol fluid cure under temperature and moisture conditions, and the amount of unreactive diluents used.

It is appreciated that only a thin coating of between 10 and about 500 microns is needed to adequately protect a plastic or rubber substrate. Coating towards the high end produce high gloss than coating at the low end. Considerably thicker coatings are wasteful of material. While a curable capped silanol fluid according to the present invention is readily applied by swabbing, pump spray, or propellant-based aerosol spray, the application of a coating having the desired thickness requires considerable skill. The most desirable products require only spraying with no other actions, such a wiping or smoothing, required. Owing to problems associated with moisture-induced cure when the inventive composition is to ambient air, preferably, the inventive composition is packaged in a single application quantity container. A container typically includes 20 to 200 grams and is preferably wholly expended in treating a single vehicle so that subsequent cure induced nozzle clogging is precluded. To facilitate ease of application, an inventive capped silanol fluid is optionally mixed with a diluent. The diluent includes a silicone polymer unreactive towards cure with the capped silanol fluid, an organic plasticizer, a solvent solubilizing the capped silanol fluid, or a combination thereof. A diluent is provided to a level of up to 97 total weight percent of the resulting formulation.

An unreactive silicone diluent is optionally present from 0 to 97 total weight percent. An unreactive silicone polymer as used herein is defined to include a polymer unreactive with a capped moiety of the capped silanol reactive fluid. Unreactive silicone polymers operative herein illustratively include fully alkylated polysiloxanes. Preferably, an unreactive silicone has a viscosity of between 50 centistokes and 60,000 centistokes. The unreactive silicone polymer has nominal volatility and tends to provide an inventive coating with a more oily, gel-like glossy film as the concentration of nonreactive silicone polymer is increased. Similarly, unreactive organic diluents, such as petroleum oils, may be used.

A solvent diluent is optionally present from 0 to 95 total weight percent with the proviso that the total diluent present does not exceed 97 total weight percent. A solvent diluent operative herein is able to solubilize the capped silanol fluid as well as the optional unreactive silicone polymer if present. Solvents operative herein illustratively include volatile silicone fluids such as polysiloxanes having a molecular weight of less than 800, cyclic polysiloxanes having a molecular weight of 900; petroleum distillates liquid at 20° C., such as aliphatic distillates and aromatic distillates; C₁-C₂₄ aliphatic alcohols; C₆-C₂₀ aromatic alcohols; esters; keto esters; ethers; and combinations of any of the above solvents.

While an inventive composition of a capped silanol fluid with an optional diluent therein is readily applied to a substrate by swabbing or pump spray, it is appreciated that coating uniformity is readily obtained by application from a spray aerosol can. As such, a propellant is optionally added in a range from 5 to 95 total weight percent with the proviso that the propellant and diluent together do not exceed 97 total weight percent of the formulation. Suitable propellants include those that are unreactive towards the capped silanol fluid and illustratively include alkanes such as butane, pentane, isobutane, propane; ethers such as dimethyl ether, diethyl ether, nitrogen; halogenated hydrocarbons; carbon dioxide and combinations thereof The resultant formulation inclusive of a propellant is seated within a conventional metal aerosol canister and applied by spray application.

Regardless of the mode of application, after application of an inventive formulation, a period of time is provided based on temperature and humidity during which the reactive capped silanol fluid cures and volatile solvent evaporates. The resulting coating has a high gloss. The inventive coating is removed through usage of a detergent solution and water jet or mechanical scrubbing.

The following nonlimiting examples are provided to further illustrate preparation of inventive formulations and certain attributes associated with the resultant coatings.

### EXAMPLE 1

Uncured silicone compositions are prepared with the following proportions of ingredients as shown in Table 1.

TABLE 1
Uncured Silicone Coating Formulations

| | Total wt % | | | |
|---|---|---|---|---|
| Ingredient | A | B | C | D |
| Silanol fluid | | | | |
| 6000 cst silanol fluid* | 4.0 | 20.0 | 20 | 4.0 |
| Crosslinking silane | | | | |
| Vinyl trixoimino silane | 1.0 | | | 1.0 |
| Tetra(methyl ethyl ketoximino) silane | | 1.0 | 1.0 | |
| Diluent unreactive silicone | | | | |
| 1000 Cst silicone fluid | 20.0 | 0 | 0 | 20.0 |
| Diluent solvent | | | | |
| Heptane | 75.0 | 0 | 79.0 | 0 |
| Propellant | | | | |
| Propane | 0 | 79.0 | 0 | |
| Liquefied petroleum gas | | | | 75.0 |

*Wacker Silicones

Compositions are mixed by combining the silanol fluid and optional nonvolatile silicone and/or solvents and thereafter introducing the crosslinking agent with mechanical stirring at ambient temperature. The composition is allowed to stir for 10 minutes under a nitrogen blanket and a measured amount is transferred into a metal aerosol canister that is subsequently pressurized.

### EXAMPLE 2

Each of the compositions of Table 1 is applied to a radial section of a vehicle tire along with the composition produced according to Example 1 of U.S. Pat. No. 5,844,007. Exemplary compositions A-D and the comparative composition all exhibited a high gloss with compositions B and C having a tack-free finish while exemplary compositions A and D had an oily gelatinous finish. The vehicle was driven under both city and highway conditions under summer driving conditions with daily evaluation of coating appearance. The time after which the high gloss sheen was observed to have been degraded is noted as shown in Table 2.

TABLE 2
Sheen Degradation Time Observed Through Driving

| Sample | Time (in days) |
|---|---|
| A | 10 |
| B | >20* |
| C | >20* |
| D | 10 |
| Comparative Example | 3 |

*gloss restored after gentle washing

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof are intended to define the scope of the invention.

1. A curable silicone composition comprising:
a silanol functional silicone fluid;
a crosslinker reactive with said silanol functional silicone fluid to yield a capped reactive silanol fluid;
a diluent selected from the group consisting of: a nonvolatile unreactive silicone, an organic plasticizer, and a volatile solvent; and
a propellant capable of expelling the composition from an aerosol container.

2. The composition of claim 1 wherein said propellant is an alkane.

3. The composition of claim 1 wherein said diluent is a solvent selected from the group consisting of: petroleum distillates liquid at 20° C., C₁-C₂₄ aliphatic alcohols, C₆-C₂₀ aromatic alcohols, esters; keto esters, ethers; and combinations thereof.

4. A curable silicone composition consisting essentially of:
a silanol functional silicone fluid;
a crosslinker reactive with said silanol functional silicone fluid to yield a capped reactive silanol fluid;
an optional diluent selected from the group consisting of: a nonvolatile silicone unreactive or organic plasticizer with said capped silanol fluid and a volatile solvent; and
an optional propellant.

5. The composition of claim 4 wherein said silanol terminated silicone fluid has a viscosity between 100 and 1,000,000 centistokes.

6. The composition of claim 4 wherein said diluent is present up to 97 total weight percent.

7. The composition of claim 4 wherein said propellant is present from 5 to 90 total weight percent.

8. The composition of claim 4 wherein said diluent comprises a polysiloxane and a solvent.

9. The composition of claim 8 wherein said solvent is selected from the group consisting of: petroleum distillates liquid at 20° C., C₁-C₂₄ aliphatic alcohols, C₆-C₂₀ aromatic alcohols, esters, keto esters, ethers, and combinations thereof.

10. The composition of claim 8 wherein said polysiloxane has a viscosity of from 100 centistokes to 60,000 centistokes.

11. A silicone coating comprising a cure product of a silanol fluid capped with a silane crosslinker cured in ambient air for 60 minutes or less with the proviso that said composition is independent of a condensation cure catalyst inclusive of a moiety selected from the group consisting of: a tin atom, a titanate, a zirconate, or an amine.

12. The coating of claim 11 further comprising a nonreactive silicone diluent.

13. The coating of claim 12 wherein said silicone is present from 70 to 95 total weight percent of said coating.

14. A vehicle tire comprising:
a circular rubber substrate having a sidewall; and
a coating of claim 11 applied to the sidewall.

15. The tire of claim 14 wherein the coating is tack free.

16. The tire of claim 15 wherein the coating has a thickness of between 10 and 500 microns.
